(19) United States
(12) Patent Application Publication
(10) Pub. No.: US 2014/0279874 A1
(43) Pub. Date: Sep. 18, 2014

(54) SYSTEMS AND METHODS OF DATA STREAM GENERATION

(71) Applicants: Timmie G. Reiter, Westborough, MA (US); Ronald Ray Trimble, Acton, MA (US)

(72) Inventors: Timmie G. Reiter, Westborough, MA (US); Ronald Ray Trimble, Acton, MA (US)

(21) Appl. No.: 13/839,160

(22) Filed: Mar. 15, 2013

(51) Int. Cl. G06F 17/30

(52) U.S. Cl. CPC G06F 17/30575
USPC 707/610

(57) ABSTRACT

A system configured to generate data having one or more predetermined characteristics is provided. The system includes memory, at least one processor, and at least one data stream component. The at least one data stream component is executed by the at least one processor and configured to read at least one first parameter descriptive of the one or more predetermined characteristics, identify a target sequence of data based on the at least one first parameter, execute a plurality data generator components to generate one or more data chunks, and assemble the target sequence from the one or more data chunks into at least one data stream. The at least one first parameter descriptive of one or more predetermined characteristics may include at least one of a compression ratio parameter, a multiplex degree parameter, a data change ratio parameter, and a total stream size parameter.

### BACKGROUND

1. Technical Field

Aspects and embodiments relate to data generation, and more particularly to apparatus and methods for generating data with predetermined characteristics.

2. Discussion

Commercially available backup applications rely on a multi-level architecture to perform backup jobs. These backup applications have components to schedule jobs, merge multiple clients into one or more streams, manage media, and abstract the backup media (i.e., OST, tape or disk). These components are layered, much like an Operating System (OS) would layer device drivers for file systems. The characteristics of the data copied for backup is a product of this layering. For example, backup jobs (which are also referred to as policies) govern all aspects of the backup process and control of one or more clients. Clients copy data based on the backup job, which eventually provide data to one or more data backup systems for storage.

One such data backup system may be a virtual tape library, such as the SEPATON S2100-ES3, that integrates with third party backup solutions. Third party backup solutions interface with the virtual tape library as an ordinary tape drive system. Virtual tapes, much like real tapes, are written to sequentially. In order to reclaim space, storage system vendors often incorporate de-duplication processes into their product offerings to decrease the amount of required back-up media. One such method for identifying redundant data within back-up data streams is disclosed in U.S. application Ser. No. 12/877,719, entitled “SYSTEM AND METHOD FOR DATA DRIVEN DE-DUPLICATION” assigned to Sepaton, Inc. of Marlborough, Mass.

### SUMMARY

The ability to replicate data with the same variable characteristics of data generated from third party backup solutions is highly desirable. Conventional approaches utilize existing libraries to generate a single data stream (also known as a client). In some embodiments, by changing different parameters, different data qualities may be generated. These qualities include compressibility, starting seed, chunk size, amount of unique data from generation to generation, and the total size of the stream.

Aspects and examples disclosed herein relate to apparatus and processes for generating data having one or more predetermined characteristics. Some examples manifest an appreciation that conventional data generation techniques are constrained by the number of streams data may be generated to, and the granularity of the control over the data generated. For example, existing data generation techniques may generate a stream that is highly (100%) compressible or 100% random (non-compressible), with no variations in between. The ability to generate data closely resembling copied data that originated from one or more streams, utilizing third party backup solutions is highly desirable. Further, these examples manifest an appreciation that conventional data generation techniques do not have the ability to reproduce a previous generation of generated data, identically, based on one or more parameters. Thus, these examples manifest an appreciation of the limitations imposed by conventional data generation techniques.

For instance, some examples provide for a system configured to generate data having one or more predetermined characteristics. The system includes memory, at least one processor coupled to the memory, and at least one data stream component. The at least one data stream component is executed by the at least one processor and configured to read at least one first parameter descriptive of the one or more predetermined characteristics, identify a target sequence of data based on the at least one first parameter, execute a plurality data generator components to generate one or more data chunks, and assemble the target sequence from the one or more data chunks into at least one data stream. The at least one first parameter descriptive of the one or more predetermined characteristics may include at least one of a compression ratio parameter, a multiplex degree parameter a data change ratio parameter, and a total stream size parameter. In addition, each data generator component of the plurality of data generator components may be configured to write at least one variable sequence of random numbers to at least one data chunk of the one or more data chunks. Moreover, the plurality of data generators may write at least one variable sequence of random numbers, which includes a repeated random number of the same value, or a plurality of randomly generated numbers. The system may be further configured to assemble the target sequence by assembling a majority of the target sequence from data chunks generated by a first subset of the plurality of data generators and by assembling a minority of the target sequence from data chunks generated by a second subset of the plurality of data generators different from the first subset. In addition, the system may include the at least one data stream component that is configured to randomly select the first subset from the plurality of data generator components.

The system may also include a client job component executed by the at least one processor and configured to read at least one second parameter descriptive of the one or more predetermined characteristics, identify a first target sequence of streams based on the at least one second parameter, initiate a plurality of data stream components that generates a plurality of data streams; and assemble the first target sequence of streams from the plurality of data streams. In addition, the at least one second parameter descriptive of the one or more predetermined characteristics may be different during a subsequent execution of the client job component. Further, the system may be configured with each data stream of the plurality of data streams including data having characteristics different from others of the plurality of data streams. The system may further include another client job component executed by the at least one processor and configured to read the least one second parameter descriptive of the one or more predetermined characteristics, identify a second target sequence of streams based on the at least one third parameter, initiate one or more data stream components that generate one or more data streams, and assemble the second target sequence of streams from the one or more data streams. Thus, the second target sequence of streams may be identical to the first target sequence of streams.

The system may be further configured to verify at least a portion of the target sequence, wherein the target sequence is stored in one or more generations of data stored on hard drive of a data storage system.

According to another example, a method for generating data having one or more predetermined characteristics with at least one data stream component is provided. The method includes acts of reading at least one first parameter descriptive of the one or more predetermined characteristics, identifying, by the at least one data stream component, a target sequence of data based on the at least one first parameter, generating, by the plurality of generator components, one or more data chunks, and assembling the target sequence from the one or more data chunks into the least one data stream. In addition, the method may include the act of writing at least one variable sequence of random numbers to at least one data chunk of the one or more data chunks. The at least one variable sequence of random numbers may be one of a repeated random number of the sale value, a plurality of randomly generated numbers.

The method may further include an act of assembling the target sequence which may include the act of assembling a composition of a majority of data chunks generated by a first subset of a plurality of data generators, and a minority of the target sequence from data chunks generated by a second subset of the plurality of data generators different from the first subset. The composition may include a randomly determined order from the first subset of a plurality of data generators and the second subset of the plurality of data generators.

The method may further include acts of reading at least one second parameter descriptive of the one or more predetermined characteristics, identifying a first target sequence of streams based on the at least one second parameter, initiating, by a client job, a plurality of data streams, and assembling, by the client job, the first target sequence of streams from the plurality of data streams. Each data stream of the plurality of data streams may include data having characteristics different from others of the plurality of data streams. The method may further include the acts of reading the at least one second parameter descriptive of the one or more predetermined characteristics, identifying a second target sequence of streams based on the at least one second parameter assembling the second target sequence of streams from the one or more data streams. Thus, the second target sequence of streams may be identical to the first sequence of streams.

According to another example, a non-transitory computer readable medium storing computer readable instructions is provided. The computer readable medium stores computer readable instructions that, when executed by at least one processor, instruct the at least one processor to perform a method of generating data having one or more predetermined characteristics. This method includes the acts of reading at least one first parameter descriptive of the one or more predetermined characteristics, identifying a target sequence of data based on the at least one first parameter, generating, by a plurality of data generators, one or more data chunks; and assembling the target sequence from the one or more data chunks into at least one data stream. Further, the instructions for generating data having one or more predetermined characteristics may instruct the at least one processor to order the one or more data chunks in a pattern established in proportion to a ratio of a first subset of the plurality of data generators and a second subset of the plurality of data generators different from the first subset.

Still other aspects, examples, and advantages of these exemplary aspects and examples, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. Any example or embodiment disclosed herein may be combined with any other example or embodiment. References to “an example,” “an embodiment,” “some examples,” “some embodiments,” “an alternate example,” “an alternate embodiment,” “various examples,” “various embodiments,” “one example,” “one embodiment,” “at least one example,” “at least one embodiment,” “this and other examples,” “this and other embodiments,” or the like are not necessarily mutually exclusive and are intended to indicate that a particular feature, structure, or characteristic described in connection with the example may be included in at least one example or embodiment. The appearances of such terms herein are not necessarily all referring to the same example or embodiment.

### BRIEF DESCRIPTION OF DRAWINGS

Various aspects of at least one example are discussed below with reference to the accompanying figures, which are not intended to be drawn to scale. The figures are included to provide an illustration and a further understanding of the various aspects and examples, and are incorporated in and constitute a part of this specification, but are not intended as a definition of the limits of the embodiments disclosed herein. The drawings, together with the remainder of the specification, serve to explain principles and operations of the described and claimed aspects and examples. In the figures, each identical or nearly identical component that is illustrated in various figures is represented by a like numeral. For purposes of clarity, not every component may be labeled in every figure. In the figures:

FIG. 1 is a block diagram of one example of a data generation system configured to perform processes disclosed herein;

FIG. 2 is a block diagram illustrating data generation parameters used during data generation methods disclosed herein;

FIG. 3 is a block diagram of one example of a data generator configured to generate data in accordance with methods disclosed herein;

FIG. 4 is a block diagram illustrating an example sequence of compression groups;

FIG. 5 is a block diagram illustrating an example sequence of compression groups in relation to chunks;

FIG. 6 is a block diagram of one example of a networked computing environment including a storage system according to aspects of the invention;

FIG. 7 is a block diagram of one example of a storage system configured to perform processes disclosed herein;

FIG. 8 is a block diagram illustrating a plurality of data generators multiplexed into one data stream;

FIG. 9 is a flow diagram of a method for generating data with predetermined characteristics;

FIG. 10 is a schematic layout of an example stream with predetermined characteristics;

FIG. 11 is a schematic layout of one specific example of data changes within multiple generations of generated data;

FIG. 12 is another schematic layout of multiple generations of data simulating a daily full backup; and

FIG. 13 is a schematic layout of an example of how multiple data stream components may simulate striping during data generation.

### DETAILED DESCRIPTION

Some aspects and embodiments relate to apparatus and processes for generating data having one or more predetermined characteristics. For example, according to one embodiment, a data generation system is configured to read a plurality of data generation parameters. Based on the data generation parameters, one or more data stream components are initialized and executed by the data generation system. The one or more data stream components may generate data, using a plurality of data generators, in accordance with the predetermined characteristics targeted by the data generation parameters. The generated data may be a generation of data that simulates a daily full or incremental backup. Thus, subsequent generations of data may be generated, identical to the previous, if the same data generation parameters are used. In addition, subsequent generations of data may be generated, similar to the first, but with one or more changes based on changing certain parameters within the data generation parameters.

The predetermined characteristics may represent data characteristics of a particular target data footprint. Such predetermined characteristics may include data with target compression ratios, target data change ratios, and granular size of data. To this end, embodiments of this disclosure demonstrate how data generation parameters enable fine-grain control over generated data to achieve a particular data footprint. For example, data generation parameters may target characteristics of a particular database type. In certain embodiments, this may be a relational database. A data footprint simulating a relational database, depending on a database vendor's specific implementation (and the data stored therein), may include a specific predetermined number of streams, a compression ratio and de-duplication ratio. In certain other embodiments, the data footprint may simulate a file system with widely varying characteristics. Data generation parameters are discussed below in further detail in regards to FIG. 2. It should be understood that a custom data footprint may be also targeted. Such a custom data footprint may be unlike any data normally copied through a commercial backup application, but instead may be valuable to test the processes of storage systems (such as the storage system 170 described in further detail below in regards to FIG. 7). Moreover, various embodiments herein may be valuable for benchmarking such processes and stress testing. Specific non-limiting examples of custom data footprints are discussed below in regards to FIGS. 11 and 12.

Embodiments disclosed herein further include one or more data stream components having stream objects connected to one or more destination storage systems. These destination storage systems may be connected in a number of ways, such as logically, by sockets, and physically, through the use of Ethernet, IEEE 1394 (Firewire), Fiber Optics, IEEE 802.11 (Wifi), USB, Bluetooth, or any method for transmitting data between computer systems.

Also, in at least one embodiment disclosed herein, the data generation system is further configured to provide data verification parameters inline to a generated data stream as a constant value or string. Responsive to the availability of such values within a generated stream, the data generation system may verify data integrity before, during, or after certain processes (e.g., de-duplication or compression) of a storage system alter the generated data. In other embodiments, no verification values may be provided within the generated stream, and therefore, no verification may occur.

Certain embodiments disclosed herein also include providing feedback regarding progress of data generation to the user of the data generation system. Feedback may be in the form of a progress bar, or on-screen report. Such feedback may include the percent of completion of the current generation, overall generations, etc. Other such feedback may include reports indicating whether verification was successful. In addition, feedback may include any error that occurs, for example any exception/fault, or connectivity issue with the data streams.

It is to be appreciated that examples of the methods and apparatuses discussed herein are not limited in application to the details of construction and the arrangement of components set forth in the following description or illustrated in the accompanying drawings. The methods and apparatuses are capable of implementation in other examples and of being practiced or of being carried out in various ways. Examples of specific implementations are provided herein for illustrative purposes only and are not intended to be limiting. In particular, acts, elements and features discussed in connection with any one or more examples are not intended to be excluded from a similar role in any other examples.

Also, the phraseology and terminology used herein is for the purpose of description and should not be regarded as limiting. Any references to examples or elements or acts of the systems and methods herein referred to in the singular may also embrace examples including a plurality of these elements, and any references in plural to any example or element or act herein may also embrace examples including only a single element. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

Furthermore, the data manipulated by examples disclosed herein may be organized into various data objects on one or more computer systems. These data objects may include any structure in which data may be stored. A non-limiting list of exemplary data objects includes bits, bytes, data files, data blocks, data directories and back-up data sets.

### Data Generation System

Various embodiments utilize one or more devices or computer systems to generate data having one or more predetermined characteristics. FIG. 1 illustrates one of these embodiments, a data generation system generally designated at 100. The data generation system may be included in one or more computer systems, as described in further detail below in regards to FIGS. 6 and 7. As shown, FIG. 1 includes data generation parameters object 102, a data stream component object 104, a plurality of data generators 106, and a data stream component 108.

### Data Generation Parameters

As depicted in FIG. 2, with additional reference to FIG. 1, the data generation parameters object 102 includes categories of parameters that affect data generation. Each parameter used by the data generation system 100 (FIG. 1) during data generation, may be classified in one or more categories (or groups) of parameters that describe the relationship that each parameter has with resulting data generations. These categories include parallelism parameters 202, data characteristic parameters 204, generational parameters 206, and verification parameters 208. Each of the categories is explored in further detail below.

Parallelism parameters 202 are a category of parameters generally directed to generation of data in a manner which is similar (temporally and spatially) to data copied by commercial backup processes. In one embodiment, these parallelism parameters specify the number of concurrent data originators (backup clients). Further parameters may be included that maintain a consistent timing, or randomly adjust certain delays in regards to maintaining the temporal relationship between parallel data originators. For example, a commercial backup application may copy data through parallel clients (using one or more streams). The copied data of these parallel clients would be sequenced, or “striped,” on a storage system. Striping is discussed in further detail below in regards to FIG. 13. To this end, it is necessary that generated data simulate this behavior in order to achieve a target data footprint. It should be noted that by adjusting certain delays, the spatial relationship between simultaneous parallel data originators (e.g., as received and processed by virtual tape system, cloud storage, or other mass storage service), may also be adjusted to further simulate certain peculiarities of data streams created by commercial backup applications.

One or more data characteristic parameters 204 may be contained within the data generation parameters object 102. In various embodiments, data characteristic parameters 204 may affect certain underlying characteristics of one or more generated data streams, over the course of several generations. In accordance with these embodiments, each data stream may have underlying characteristics which allows each stream to have unique qualities and characteristics different from others. In one embodiment, data characteristic parameters 204 may include a parameter which controls the variability of the underlying generated data. Variability may be controlled by several parameters which control the target compressibility (compression ratio) of the stream based on randomized data generation. Compressibility is discussed in further detail below in regards to FIG. 4. In another embodiment, variability may include a parameter which controls a percentage of data change within the underlying stream over the course of several generations of data during data generation. Storage systems (such as the storage system 170 illustrated in FIG. 7) attempt to reduce the amount of space each client uses when transferring copied data for long term storage. Storage systems generally examine a previous copy, or generation, of data being copied to determine if space may be saved through de-duplication. Such a de-duplication procedure is discussed in further detail below in regards to FIG. 7. How variability between generations of data, and in some embodiments a single generation of data, is controlled and discussed further in detail below in regards to FIGS. 10, 11 and 12.

In one example embodiment, streams of data are a delineated and constructed by a plurality of chunks. Chunks, as used herein, are defined as a block of data stored in physically or logically contiguous memory having a defined size. In some embodiments, chunks are a basic unit of generated data. In certain embodiments, chunks may be grouped together into a chunk group (or buffer) that may include a header and/or footer. It should be noted that a chunk group may contain as few as one chunk. In one embodiment, chunk size may be a parameter of the data characteristic parameters 204. It should also be noted that certain other parameters may be defined, such as the generation size parameter, which is discussed further below, which may also affect chunk size. In one embodiment, a parameter may be defined that determines the overall number of chunks to be generated, and thus, also defines the overall size of the generated stream. In another embodiment, a parameter of the data characteristic parameters 204 may define the target chunk group size and number of chunks to include in a chunk group. In yet other embodiments, chunk size, chunk group size, chunk group composition, and generation size are all controlled by separate parameters. Chunks are described in further detail below, in reference to FIG. 5.

Certain exemplary embodiments include one or more generational parameters 206 within the data generation parameters object 102. In various embodiments, generational parameters 206 control certain aspects of data generation, such as controlling unique qualities and underlying (predetermined) characteristics of each generated stream. The predetermined characteristics may change from one generation to the next during data generation. In one embodiment, a generational parameter controls the number of generations to be created during data generation. Further embodiments may include additional parameters such as a parameter for controlling the size of each generation. Still further examples of additional parameters may include randomization of generation size and a simulated delay period between subsequent generations. It should be noted, as was described above, that certain parameters directed towards chunk and generation size may affect the resulting generation size, and vice versa. In these embodiments, parameters are utilized, when enabled, in a harmonious and logical combination to reach desired results.

In one embodiment, verification parameters 208 may be included in the data generation parameters object 102. In some embodiments, a header and/or footer may appear in chunk groups. In accordance with these embodiments, verification parameters may control the insertion of one or more values within the headers/footers. In one embodiment, one value of a parameter may indicate a particular method to use for verifying the contents of one or more chunks. One such method may be a cyclic redundancy check (CRC). Also, it should be noted that a checksum may be used to verify the contents of one or more chunks. For example, checksums such as sum (Unix) 8/16/24/32, fletcher-4/8/16/32, Adler-32 may be used. In certain other embodiments, any suitable non-cryptographic or cryptographic method for verifying the contents of one or more chunks may be also used. For example, some non-cryptographic functions include Pearson hashing, Fowler-Noll-Vo (FNV) hashing, Jenkins hash function, Java's hash_CodeQ, and MurmurHash. Cryptographic methods for verifying the contents may be, for example, SHA-1/256/512, MD5 and FSB. The verification methods may be chosen based on target hardware and performance requirements. In one embodiment, a parameter may indicate that no verification should be performed. In still other embodiments, a parameter may control when and how verification is to occur with granularity. For example, a parameter may direct that verification should be performed during or after each generation, or at a chosen multiple of generations, or even at random. In another example, a parameter may limit verification to only the last generation. Still another example is a parameter that indicates some number of chunks of each generation to be verified. The number may be fewer than all of the chunks.

Further parameters may indicate the method in which verification results should be provided to a user 110 (FIG. 1) of the data generation system 100 (FIG. 1). For example, a parameter may indicate that the user 110 should be prompted with an on screen message in the event verification fails. In certain embodiments, a parameter may direct that results of verification procedures should only be reported at the end of a verification procedure. Results may be reported in a number of ways, including using a GUI or console window, an email report, a log file, an event log, or as a row in a database table.

As described above in reference to FIG. 2, in one embodiment a parameter controls the delay between generations. Such a delay may be affected by one or more verification parameters 208 described above. In this embodiment, the delay parameter may determine the maximum amount of time that a verification procedure may occur before the data generation process creates another generation. In other embodiments delay and generational parameters may be used in different ways. For example, the delay parameter may determine a minimum amount of time between generations, regardless of how long verification may take. A parameter may also indicate that verification of previous generations will occur in parallel to the creation of new generations. In one embodiment, a parameter may indicate that a user's interaction (input) is required before conducting verification of a generation, or if a parameter indicates no verification is a required, before the creation of a subsequent generation. It is to be appreciated that user input may include any user initiated action detectable by a computer system, such as a key stroke, mouse click, verbal command, or the like.

### Data Stream Component

With continued reference to FIG. 1, a data stream component 104 includes data generators 106 and a data stream 108. Although only one data stream component 104 appears in the data generation system 100, the data generation system 100 may contain a plurality of data stream components. In certain embodiments, the data generation system 100 is configured to read one or more data generation parameters and store them in the data generations parameters object 102 and, based on the values of these parameters, compute the number of data stream components to instantiate to perform the data generation. In one embodiment, each data stream component 104 contains a plurality of data generators 106 that each create one or more chunk objects by arranging one or more compression groups. In certain other embodiments, the data stream component 104 combines one or more sequences of chunks from the data generators 106 to create the unique qualities specified by the data generation parameters object 102. The generation of chunks by the data generators 106 is discussed further below in regards to FIGS. 4 and 5. The combining of one or more sequence of chunks by the data stream component 104 is discussed further below in regards to FIG. 8.

Referring now to FIG. 3, with additional reference to FIG. 1, a data generator of the plurality of data generators 106 (FIG. 1) is generally designated at 300. The data generator 300 includes a random number generator 302, a starting seed 304, and data characteristic parameters 306. In one embodiment, the data generator 300 is responsible for generating a repeatable, compressible and unique sequence of chunks of data based on one the data characteristic parameters 306. The data characteristic parameters 306 may include a number of parameters identical to the parameters in the data generation parameters object 102 (FIG. 1). Data characteristic parameters 306 may be provided by the data stream component 104 when the data generator 300 is initialized by the data stream component 104. In addition, the data generator 300 may be provided private parameters. In some embodiments, the data generator 300 may generate private parameters from the parameters based on the data characteristic parameters 306. The private parameters may include a starting seed, or a value indicating a particular value to insert into the header or footer of one or more chunk groups. The starting seed may be stored for future reference at 304.

### Random Number Generator

The random number generator 304 may be any pseudo random number generator (PRNG) that is capable of generating a long sequence of random numbers. The sequence of numbers is generally determined from a fixed number called a seed. A common PRNG is the traditional linear congruential generator. However, the period length of PRNGs, such as the linear congruential generators, are limited most often to 2³² or 2⁶⁴. The traditional PRNG may be sufficient to generate the quality of randomness needed. In certain other embodiments, the Mersenne twister algorithm may be implemented in the random number generator 302. In further embodiments, a linear feedback shift register PRNG may be implemented in the random number generator 302. In still further embodiments, the scalable parallel random number generator library (SPRNG) may be implemented in the random number generator 302.

Still referring to FIG. 3, with reference to FIG. 1, any number of random number generator algorithms may be implemented in the random number generator 302. In one embodiment, each random number generator of the plurality of random number generators 106 (FIG. 1) may include an identical random number generator implementation. In other embodiments, each random number generator of the plurality of data generators 106 (FIG. 1) may include one or more random number generators with different random number generator implementations. Mixing random number generators provides the quality of randomness that certain sophisticated random number generators provide, but also saves resources by generating a portion of random sequences of numbers using traditional PRNGs.

### Compression Groups

Now referring to FIG. 4, with further reference to FIG. 3, a sequence of compression groups is generally designated at 400. The sequence of compression groups 400 includes compression group 1, compression group 2, a compression group 3, and variable number of compression groups at 402, 404, 406 and 408, respectively. In one embodiment, a compression group includes a sequence of random 32 bit numbers. In other embodiments, a compression group includes a sequence of 64 bit random numbers. In one embodiment, each compression group may be 4 KB in size. Depending on the target compression ratio, the length of the sequence of random numbers within the compression group is varied—this is known as a pattern. For example, if a data characteristic parameter 306 indicates that a 4 KB chunk of non-compressible data is to be generated, a compression group would be formed with a pattern of 512 randomly generated 64 bit numbers. Conversely, if a highly compressible chunk is desired, a pattern of a single repeating random number would be formed.

According to one embodiment, having a compression group 4 KB in size allows for a data compression algorithm, such as Lampel-Ziv-Stac (LZS, or Stac compression), to use a sliding window compression algorithm to control resulting compression ratios in generated data LZS a common algorithm used by virtual tape systems and other storage systems to compress data. In certain embodiments, a consistent rate of compressibility may be used to control the overall ratio of compressible data in the stream by maintaining control over how many highly compressible compression groups are introduced into the data stream. To this end, introducing a continuous sequence of highly compressible compression groups to a data stream would yield nearly 100% compression rate. Likewise, introducing a series of compression groups wherein only 10% were compressible may yield nearly a 10% compression ratio for the data stream overall. Thus, the data characteristic parameters 306 (FIG. 3) may be used to determine how many compressible and non-compressible groups may be introduced into a data stream by the data stream component 104 (FIG. 1) to yield a desired compression ratio.

### Data Stream

Now referring back to FIG. 1, a data stream 108 is generated in each data stream component. A data stream, as used herein, is a sequence of digitally encoded coherent signals (packets) used to transmit or receive information. To this end, a data stream 108 may contain one or more data streams transmitted to one or more data storage systems or in certain embodiments, general purpose computers or other devices capable of communication over a data stream. Data streams that may be connected via different methods are well known in the art. For example, a data stream may be transmitted over a TCP/IP based socket. Other examples, as discussed above, may include Ethernet, IEEE 1394 (Firewire), Fiber Optics, IEEE 802.11 (Wifi), USB, Bluetooth, or any method for transmitting data between computer systems. In one embodiment, the data generation system connects to data storage systems through means similar to commercially available backup solutions. In this embodiment, the data generation system may be coupled over a switching network through a port adapter connected to a storage system. As described below in further detail in regards to FIG. 7, such a port adapter may be, for example, a Fibre Channel port adapter. In other embodiments, the storage generation system may be executed within the storage system and may not require a physical connection with the switching network to communicate with the storage system.

### Chunks

Now referring to FIG. 5, in further reference to FIGS. 3 and 4, a sequence of compression groups is overlaid onto two chunks accordance with one embodiment at 500. Chunks designated as 502 and 504 include compression groups indicated at 402, 404, 406 and 408 to demonstrate how the chunks would appear if inserted in a data stream 108 (FIG. 1). The data generator 300 (FIG. 3) generates chunks by arranging compression groups in a chunk until a chunk is full. The method by which a chunk is generated is discussed in further detail below in regards to FIGS. 8 and 9. In one example embodiment, the data generator 300 (FIG. 3) maintains a state parameter between calls to a data generator. By maintaining a state parameter, data generator 300 (FIG. 3) may arrange a first portion of a compression group 406 up to the end of one chunk 502, and continue arranging the second remaining portion of the compression group 406 at the start of the next chunk 504.

Components and parameters of the data generation system 104 have been discussed in various embodiments. These components, and related methods as described further below, may be implemented as specialized hardware or software components executing in one or more computer systems. There are many examples of computer systems that are currently in use. These examples include, among others, network appliances, personal computers, workstations, mainframes, networked clients, servers, media servers, application servers, database servers and web servers. Other examples of computer systems may include mobile computing devices, such as cellular phones and personal digital assistants, and network equipment, such as load balancers, routers and switches. Further, aspects may be located on a single computer system or may be distributed among a plurality of computer systems connected to one or more communications networks.

In addition, the various components and methods described herein may be executed from one or more storage systems. Referring to FIG. 6, there is illustrated in block diagram form, one embodiment of a networked computing environment including a back-up storage system 170 according to aspects of the invention. As illustrated, a host computer 120 is coupled to the storage system 170 via a network connection 121. This network connection 121 may be, for example a Fibre Channel connection to allow high-speed transfer of data between the host computer 120 and the storage system 170. It is to be appreciated that one or more user computers 136 may also be coupled to the storage system 170 via another network connection 138, such as an Ethernet connection. As discussed in detail below, the storage system may enable users of the user computer 136 to view and optionally restore back-up user files from the storage system.

The storage system includes back-up storage media 126 that may be, for example, one or more disk arrays, as discussed in more detail below. The back-up storage media 126 provide the actual storage space for back-up data from the host computer(s) 120. However, the storage system 170 may also include software and additional hardware that emulates a removable media storage system, such as a tape library, such that, to the back-up/restore application running on the host computer 120, it appears as though data is being backed-up onto conventional removable storage media. Thus, as illustrated in FIG. 6, the storage system 170 may include “emulated media” 134 which represent, for example, virtual or emulated removable storage media such as tapes. These “emulated media” 134 are presented to the host computer by the storage system software and/or hardware and appear to the host computer 120 as physical storage media. Further interfacing between the emulated media 134 and the actual back-up storage media 126 may be a storage system controller (not shown) and a switching network 132 that accepts the data from the host computer 120 and stores the data on the back-up storage media 126, as discussed more fully in detail below. In this manner, the storage system “emulates” a conventional tape storage system to the host computer 120.

According to one embodiment, the storage system may include a “logical metadata cache” 242 that stores metadata relating to user data that is backed-up from the host computer 120 onto the storage system 170. As used herein, the term “metadata” refers to data that represents information about user data and describes attributes of actual user data. A non-limiting exemplary list of metadata regarding data objects may include data object size, logical and/or physical location of the data object in primary storage, the creation date of the data object, the date of the last modification of the data object, the back-up policy name under which the data objected was stored, an identifier, e.g. a name or watermark, of the data object and the data type of the data object, e.g. a software application associated with the data object. The logical metadata cache 242 represents a searchable collection of data that enables users and/or software applications to randomly locate back-up user files, compare user files with one another, and otherwise access and manipulate back-up user files. Two examples of software applications that may use the data stored in the logical metadata cache 242 include a synthetic full back-up application 240 and an end-user restore application 300 that are discussed more fully below. In addition, a de-duplication director, which is discussed in more detail below, may use metadata to provide scalable de-duplication services within a storage system.

As discussed above, the storage system 170 includes hardware and software that interface with the host computer 120 and the back-up storage media 126. Together, the hardware and software of embodiments of the invention may emulate a conventional tape library back-up system such that, from the point of view of the host computer 120, data appears to be backed-up onto tape, but is in fact backed-up onto another storage medium, such as, for example, a plurality of disk arrays.

Referring to FIG. 7, there is illustrated in block diagram form, one example of a storage system 170 according to aspects of the invention. In one example, the hardware of the storage system 170 includes a storage system controller 122 and a switching network 132 that connects the storage system controller 122 to the back-up storage media 126. The storage system controller 122 includes a processor 127 (which may be a single processor or multiple processors) and a memory 129 (such as RAM, ROM, PROM, EEPROM, Flash memory, etc., or combinations thereof) that may run all or some of the storage system software. The memory 129 may also be used to store metadata relating to the data stored on the back-up storage media 126. Software, including programming code that implements embodiments of the present invention, is generally stored on a computer readable and/or writeable nonvolatile recording medium, such as RAM, ROM, optical or magnetic disk or tape, etc., and then copied into memory 129 wherein it may then be executed by the processor 127. Such programming code may be written in any of a plurality of programming languages, for example, Assembler, Java, Visual Basic, C, C#, or C++, Fortran, Pascal, Eiffel, Basic, COBOL, or combinations thereof, as the present invention is not limited to a particular programming language. Typically, in operation, the processor 127 causes data, such as code that implements embodiments of the present invention, to be read from a nonvolatile recording medium into another form of memory, such as RAM, that allows for faster access to the information by the processor than does the nonvolatile recording medium.

As shown in FIG. 7, the controller 122 also includes a number of port adapters that connect the controller 122 to the host computer 120 and to the switching network 132. As illustrated, the host computer 120 is coupled to the storage system via a port adapter 124a, which may be, for example, a Fibre Channel port adapter. Via a storage system controller 122, the host computer 120 backs up data onto the back-up storage media 126 and can recover data from the back-up storage media 126.

In the illustrated example, the switching network 132 may include one or more Fibre Channel switches 128a, 128b. The storage system controller 122 includes a plurality of Fibre Channel port adapters 124b and 124c to couple the storage system controller to the Fibre Channel switches 128a, 128b. Via the Fibre Channel switches 128a, 128b, the storage system controller 122 allows data to be backed-up onto the back-up storage media 126. As illustrated in FIG. 7, the switching network 132 may further include one or more Ethernet switches 130a, 130b that are coupled to the storage system controller 122 via Ethernet port adapters 125a, 125b. In one example, the storage system controller 122 further includes another Ethernet port adapter 125c that may be coupled to, for example, a LAN 103 to enable the storage system 170 to communicate with host computes (e.g., user computers), as discussed below.

In the example illustrated in FIG. 7, the storage system controller 122 is coupled to the back-up storage media 126 via a switching network that includes two Fibre Channel switches and two Ethernet switches. Provision of at least two of each type of switch within the storage system 170 eliminates any single points of failure in the system. In other words, even if one switch (for example, Fibre Channel switch 128a) were to fail, the storage system controller 122 would still be able to communicate with the back-up storage media 126 via another switch. Such an arrangement may be advantageous in terms of reliability and speed. For example, as discussed above, reliability is improved through provision of redundant components and elimination of single points of failure. In addition, in some embodiments, the storage system controller is able to back-up data onto the back-up storage media 126 using some or all of the Fibre Channel switches in parallel, thereby increasing the overall back-up speed. However, it is to be appreciated that there is no requirement that the system comprise two or more of each type of switch, nor that the switching network comprise both Fibre Channel and Ethernet switches. Furthermore, in examples wherein the back-up storage media 126 comprises a single disk array, no switches at all may be necessary.

As discussed above, in one embodiment, the back-up storage media 126 may include one or more disk arrays. In one preferred embodiment, the back-up storage media 126 include a plurality of ATA or SATA disks. Such disks are “off the shelf” products and may be relatively inexpensive compared to conventional storage array products from manufacturers such as EMC, IBM, etc. Moreover, when one factors in the cost of removable media (e.g., tapes) and the fact that such media have a limited lifetime, such disks are comparable in cost to conventional tape-based back-up storage systems. In addition, such disks can read/write data substantially faster than can tapes. For example, over a single Fibre Channel connection, data can be backed-up onto a disk at a speed of at least about 150 MB/s, which translates to about 540 GB/hr, significantly faster (e.g., by an order of magnitude) than tape back-up speeds. In addition, several Fibre Channel connections may be implemented in parallel, thereby increasing the speed even further. In accordance with an embodiment of the present invention, back-up storage media may be organized to implement any one of a number of RAID (Redundant Array of Independent Disks) schemes. For example, in one embodiment, the back-up storage media may implement a RAID-5 implementation.

As discussed above, embodiments of the invention emulate a conventional tape library back-up system using disk arrays to replace tape cartridges as the physical back-up storage media, thereby providing a “virtual tape library.” Physical tape cartridges that would be present in a conventional tape library are replaced by what is referred to herein as “virtual cartridges.” It is to be appreciated that for the purposes of this disclosure, the term “virtual tape library” refers to an emulated tape library which may be implemented in software and/or physical hardware as, for example, one or more disk array(s). It is further to be appreciated that although this discussion refers primarily to emulated tapes, the storage system may also emulate other storage media, for example, a CD-ROM or DVD-ROM, and that the term “virtual cartridge” refers generally to emulated storage media, for example, an emulated tape or emulated CD. In one embodiment, the virtual cartridge in fact corresponds to one or more hard disks.

Therefore, in one embodiment, a software interface is provided to emulate the tape library such that, to the back-up/restore application, it appears that the data is being backed-up onto tape. However, the actual tape library is replaced by one or more disk arrays such that the data is in fact being backed-up onto these disk array(s). It is to be appreciated that other types of removable media storage systems may be emulated and the invention is not limited to the emulation of tape library storage systems. The following discussion will now explain various aspects, features and operation of the software included in the storage system 170.

It is to be appreciated that although the software may be described as being “included” in the storage system 170, and may be executed by the processor 127 of the storage system controller 122 (see FIG. 7), there is no requirement that all the software be executed on the storage system controller 122. The software programs such as the synthetic full back-up application and the end-user restore application may be executed on the host computers and/or user computers and portions thereof may be distributed across all or some of the storage system controller, the host computer(s), and the user computer(s). Thus, it is to be appreciated that there is no requirement that the storage system controller be a contained physical entity such as a computer. The storage system 170 may communicate with software that is resident on a host computer. In addition, the storage system may contain several software applications that may be run or resident on the same or different host computers. Moreover, it is to be appreciated that the storage system 170 is not limited to a discrete piece of equipment, although in some embodiments, the storage system 170 may be embodied as a discrete piece of equipment. In one example, the storage system 170 may be provided as a self-contained unit that acts as a “plug and play” (i.e., no modification need be made to existing back-up procedures and policies) replacement for conventional tape library back-up systems. Such a storage system unit may also be used in a networked computing environment that includes a conventional back-up system to provide redundancy or additional storage capacity. In another embodiment, the storage system 116 may be implemented in a distributed computing environment, such as a clustered or a grid environment.

As discussed above, according to one embodiment, the host computer 120 may back-up data onto the back-up storage media 126 via the network link (e.g., a Fibre Channel link) 121 that couples the host computer 120 to the storage system 170. It is to be appreciated that although the following discussion will refer primarily to the back-up of data onto the emulated media, the principles apply also to restoring back-up data from the emulated media for verification and examination. The flow of data between the host computer 120 and the emulated media 134 may be controlled by the back-up/restore application, as discussed above. From the view point of the back-up/restore application, it may appear that the data is actually being backed-up onto a physical version of the emulated media.

### Multiplexing

As discussed above with reference to FIGS. 1 and 8 a data generation system 100 (FIG. 1) having one or more data streams components 104 (FIG. 1) may be executed by one or more computer systems, such as a storage system 170 (FIG. 6). In certain exemplary embodiments, methods may be executed to combine a sequence of chunks to create unique qualities targeted by the data generation parameters 102 (FIG. 1) over one or more generations. One embodiment includes a method for multiplexing the plurality of data generators 106 (FIG. 1) to generate data with the predetermined characteristics, and is illustrated in FIG. 9. The predetermined characteristics may be provided as data characteristic parameters 204 (FIG. 2). During data generation, the data stream component 104 (FIG. 1) selects the order in which the data generators contribute to a data stream 108. For example, in one embodiment, each generator may have different qualities (target compressibility, target chunk size, etc). Each generator may be selected in a simple round-robin fashion to generate multiplexed data. In another embodiment, the order by which the generators are selected is chosen at random. In this case, the random order is maintained throughout subsequent generations. In accordance with these embodiments, a method of a data generation is illustrated and described in further detail below in regards to FIG. 9.

In act 802, the data stream component 104 (FIG. 1) begins by initializing the plurality of data generators. It should be noted that in some embodiments a single data generator may be used. In one embodiment, each of the data generators is provided data characteristic parameters and private parameters, which may include a unique seed. Other private parameters may be any data characteristic parameter of the data characteristic parameters 204 (FIG. 2), or a value derived therefrom, to allow each data generator to generate a unique sequence of random values. At act 804, the data stream component selects a data generator and copies or makes a reference of the chunk which the selected data generator has generated. Selection of a data generator, as discussed above in regards to FIG. 8 is based on the target characteristics of the generated data. At act 806, the data stream component arranges the chunk in a chunk group. In one embodiment, the arrangement is based on the order of selection. For example, the chunk generated by the first selected random number would be positioned at the top (start) of the chunk group. In other embodiments, the order in which a chunk appears may be based on a parameter such as the generation number. In yet other embodiments, the chunk position is determined at random. Such a random order may be decided at the start of data generation and may be maintained through generations. At act 808, if the chunk group does not have the desired number of chunks (i.e., is full), the method returns to act 804. If the chunk group is full, at act 810, one or more verification parameters may be added by the data stream component to the header and/or footer of the chunk group. At act 812, the data stream component submits the chunk group to the data stream. At act 814, the method returns to act 804 if the current generation is complete. In certain embodiments, the current generation is complete based on one or more generational or data characteristics parameters, as discussed above in regards to FIG. 2 (e.g. size of the generation, the number of generations, and the overall amount of data to be generated). Moreover, verification may occur at act 814, as discussed above in regards to FIG. 2. If the current generation is complete, overall data generation may be complete and the method ends at act 816. If more than one generation has been targeted, or if the current generation has not reached a target size, the method may return to act 804. In one embodiment, a user must provide input before moving from act 814 to 804. Likewise, in another embodiment, the user must provide input before move from act 814 to act 816.

Referring to FIG. 10, with reference to FIG. 9, an example output stream generated by the method 800 is illustrated in FIG. 10. In this simplified example, only one data generator of the plurality of data generators 106 (FIG. 1) was selected to generate chunk groups indicated at 906 and each respective chunk indicated at 904. It should be understood that only one data generator of the plurality of data generators 106 may be used to generate a unique sequence. To this end, in some embodiments, only a single data generator may be instantiated by the data stream component 104. In one embodiment, each chunk group may have a small header 902 or footer (not shown). The header 902 and/or footer may contain certain verification values, as described above in regards to FIG. 2. In addition, the headers may contain identifying values such as a sequence of chunk numbers present within the chunk group 906, a chunk group number, or any other parameter based on one or more parameters of the data generation parameters object 102 (FIG. 1). In other embodiments, no header and/or footer may be included with the chunk groups.

Returning to FIG. 9, at act 804, the order by which the data generator component 104 selects one or more data generators controls certain aspects of variability within the generated data stream. The variability may be used to generate data with the underlying characteristics targeted by the data characteristic parameters 204 (FIG. 2) during the method illustrated in FIGS. 8 and 9. For example, over a given number of chunks a majority of the chunks (or higher ratio) may be from one or more generators, with a minority of chunks (or lower ratio) from one or more different generators. In one specific example, suppose a 5% target de-duplication rate targeted. To achieve this de-duplication ratio, the data stream component 104 may change every 20^{th} chunk by selecting from a second generator (with the previous 19 chunks selected from a first generator). FIG. 11 illustrates this specific example, and some other embodiments, by showing several generations generally designed at 950. Each generation includes a leading chunk 952, and subsequent chunks 954 over generations indicated at 956, 958 and 960. By selecting a leading chunk 950 from a data generator different from the subsequent chunks 954, a specific target de-duplication ratio may be reached. In accordance with this embodiment, a de-duplication process would have an older generation 956 pointing to the newest generation 960, with none pointing to the inter-mediate generation 958.

Referring to FIG. 12, data generated by one embodiment simulating generation of data representative of a daily full backup is indicated generally at 980. Each generation indicated at 982, 984, and 986 may have a varying number of chunks selected from different generators. It should be understood that any number of derivative approaches may be utilized to achieve a desired data footprint over several generations. For example, instead of always changing a leading chunk 950 (FIG. 12), a random chunk may be chosen based on the current generation value. Moreover, a group of chunks may be changed, with the group either a contiguous sequence of chunks or staggered. Further examples are discussed below.

Referring to FIG. 13, a method of striping data generated during the data generation process according to one embodiment is generally indicated at 850. The generation process 850 includes a data generation system 100, and a storage system 170. The data generation system 100 includes a plurality of data stream components 104. Also, the data generation system 100 includes a plurality of output streams 108 which are being transmitted to the storage system 170. The data streams may be transmitted to the storage system 170 and the data streams indicated at 180, 110 and 112 may be of various types, as described above in reference to FIGS. 7 and 8. In one embodiment, the data generation process executed by the data generation system simulates striping of a database from one client backup process. Such a process may be controlled by one or more parallelism parameters 202 (FIG. 2) discussed above. In this embodiment, each data stream component 104 generates data which simulates data from one or more tables of a database. In one embodiment, subsequent generations of data would simulate certain changes within the tables, and thus the database itself. It should also be understood that any number of parallel clients of a commercial backup solution may be represented by a number of data stream components 104. In this case, each data stream component may be identified by a client identifier parameter included within the data generation parameters 102 (FIG. 1). In certain other embodiments, one data stream component 104 may represent more than one client. It should be understood that by associating a number of data stream components with one or more client identifier simulates archiving behavior similar to a commercial backup solution.

Moreover, it should be understood that each data stream component 104 may generate a data stream with unique predetermined characteristics in accordance with embodiments previously described herein. Other embodiments may simulate data generated by other aspects of computer systems to be backed up. For example, certain embodiments may generate data that would be representative of certain file systems. Still other embodiments may generate data representative of certain file types, such as multi-media files including video. It should be recognized that almost any type of data (from a variable number of clients) that has definable characteristics such as distinct pattern, randomness, variability, compressibility, de-dupability, etc, may be generated by the data generation system 100 in accordance with the various embodiments described above.

Having thus described several aspects of at least one example, it is to be appreciated various alterations, modifications, and improvements will readily occur to those skilled in the art. Such alterations, modifications, and improvements are intended to be part of this disclosure, and are intended to be within the scope of the embodiments disclosed herein. Accordingly, the foregoing description and drawings are by way of example only.

What is claimed is:

1. A system configured to generate data having one or more predetermined characteristics, the system comprising:
a memory;
at least one processor coupled to the memory; and
at least one data stream component executed by the at least one processor and configured to:
read at least one first parameter descriptive of the one or more predetermined characteristics;
identify a target sequence of data based on the at least one first parameter;
execute a plurality data generator components to generate one or more data chunks; and
assemble the target sequence from the one or more data chunks into at least one data stream.

2. The system of claim 1, wherein each data generator component of the plurality of data generator components is configured to write at least one variable sequence of random numbers to at least one data chunk of the one or more data chunks.

3. The system of claim 2, wherein the at least one variable sequence of random numbers includes one of a repeated random number of the same value, a plurality of randomly generated numbers.

4. The system of claim 1, wherein the system is further configured to:
verify at least a portion of the target sequence, wherein the target sequence is stored in one or more generations of data stored on hard drive of a data storage system.

5. The system of claim 1, wherein the at least one first parameter descriptive of the one or more predetermined characteristics includes at least one of a compression ratio parameter, a multiplex degree parameter, a data change ratio parameter, and a total stream size parameter.

6. The system of claim 5, wherein the at least one data stream component is configured to:
assemble the target sequence by assembling a majority of the target sequence from data chunks generated by a first subset of the plurality of data generators and by assembling a minority of the target sequence from data chunks generated by a second subset of the plurality of data generators different from the first subset.

7. The system of claim 6, wherein the at least one data stream component is configured to randomly select the first subset from the plurality of data generator components.

8. The system of claim 5, further comprising a client job component executed by the at least one processor and configured to:
read at least one second parameter descriptive of the one or more predetermined characteristics;
identify a first target sequence of streams based on the at least one second parameter;
initiate a plurality of data stream components that generates a plurality of data streams; and
assemble the first target sequence of streams from the plurality of data streams.

9. The system of claim 8, wherein the at least one second parameter descriptive of the one or more predetermined characteristics is different during a subsequent execution of the client job component.

10. The system of claim 8, wherein each data stream of the plurality of data streams includes data having characteristics different from others of the plurality of data streams.

11. The system of claim 8, further comprising another client job component executed by the at least one processor and configured to:
read the least one second parameter descriptive of the one or more predetermined characteristics;
identify a second target sequence of streams based on the at least one third parameter;
initiate one or more data stream components that generate one or more data streams; and
assemble the second target sequence of streams from the one or more data streams, wherein the second target sequence of streams is identical to the first target sequence of streams.

12. A method for generating data having one or more predetermined characteristics with at least one data stream component, the method comprised of:
reading at least one first parameter descriptive of the one or more predetermined characteristics;
identifying, by the at least one data stream component, a target sequence of data based on the at least one first parameter;
generating, by the plurality of generator components, one or more data chunks; and
assembling the target sequence from the one or more data chunks into the least one data stream;

13. The method of claim 12, further comprising:
writing at least one variable sequence of random numbers to at least one data chunk of the one or more data chunks, wherein the at least one variable sequence of random numbers is one of a repeated random number of the sale value, a plurality of randomly generated numbers.

14. The method of claim 12, wherein assembling the target sequence includes assembling a composition of a majority of data chunks generated by a first subset of a plurality of data generators and a minority of the target sequence from data chunks generated by a second subset of the plurality of data generators different from the first subset.

15. The method of claim 14, wherein the composition includes a randomly determined order from the first subset of a plurality of data generators and the second subset of the plurality of data generators.

16. The method of claim 12, further comprising:
reading at least one second parameter descriptive of the one or more predetermined characteristics;
identifying a first target sequence of streams based on the at least one second parameter;
initiating, by a client job, a plurality of data streams; and
assembling, by the client job, the first target sequence of streams from the plurality of data streams.

17. The method of claim 16, wherein each data stream of the plurality of data streams includes data having characteristics different from others of the plurality of data streams.

18. The method of claim 16, further comprising:
reading the at least one second parameter descriptive of the one or more predetermined characteristics;
identifying a second target sequence of streams based on the at least one second parameter;
assembling the second target sequence of streams from the one or more data streams, wherein the second target sequence of streams is identical to the first sequence of streams.

19. A non-transitory computer readable medium storing computer readable instructions that, when executed by at least one processor, instruct the at least one processor to perform a method of generating data having one or more predetermined characteristics, the method comprising:
reading at least one first parameter descriptive of the one or more predetermined characteristics;
identifying a target sequence of data based on the at least one first parameter;
generating, by a plurality of data generators, one or more data chunks; and
assembling the target sequence from the one or more data chunks into at least one data stream;

20. The computer readable medium according to claim 19, wherein the instructions further instruct the at least one processor to order the one or more data chunks in a pattern established in proportion to a ratio of a first subset of the plurality of data generators and a second subset of the plurality of data generators different from the first subset.
